(19) United States
(12) Patent Application Publication
(10) Pub. No.: US 2023/0328694 A1
(43) Pub. Date: Oct. 12, 2023

(54) FLEXIBLE UPLINK TRANSMISSION SKIPPING

(71) Applicant: QUALCOMM Incorporated, San Diego, CA (US)

(72) Inventors: Diana MAAMARI, San Diego, CA (US); Prashanth Haridas HANDE, San Diego, CA (US); Mickael MONDET, Louannec (FR); Hyun Yong LEE, San Diego, CA (US); Tao LUO, San Diego, CA (US)

(21) Appl. No.: 17/718,455

(22) Filed: Apr. 12, 2022

(51) Int. Cl. H04W 72/02; H04W 72/04; H04W 72/14; H04W 24/08

(52) U.S. Cl. CPC H04W 72/02; H04W 72/0413; H04W 72/042; H04W 72/048; H04W 72/14; H04W 72/044; H04W 24/08

(57) ABSTRACT

Certain aspects of the present disclosure provide techniques for wireless communication by a user equipment (UE). The techniques generally include receiving, from a network entity, a configuration for flexible uplink transmission skipping, selecting a reduced set of resources from a set of allocated resources, in accordance with the configuration, and transmitting a physical uplink shared channel (PUSCH) on the reduced set of resources.

### BACKGROUND

### Field of the Disclosure

Aspects of the present disclosure relate to wireless communications, and more particularly, to techniques for skipping uplink transmissions.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method of wireless communications by a user equipment (UE). The method includes receiving, from a network entity, a configuration for flexible uplink transmission skipping; selecting a reduced set of resources from a set of allocated resources, in accordance with the configuration; and transmitting a physical uplink shared channel (PUSCH) on the reduced set of resources.

Another aspect provides a method of wireless communications by a network entity. The method includes transmitting, to a UE, a configuration for flexible uplink transmission skipping; and monitoring for PUSCH transmissions sent, by the UE, on a reduced set of resources selected, in accordance with the configuration, from a set of resources allocated to the UE.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts a flow diagram for uplink transmission skipping.

FIG. 6 depicts a call flow diagram for flexible uplink transmission skipping, in accordance with aspects of the present disclosure.

FIG. 7 depicts a flow diagram for flexible uplink transmission skipping, in accordance with aspects of the present disclosure.

FIG. 8 depicts an example set of RBs for flexible uplink transmission skipping, in accordance with aspects of the present disclosure.

FIG. 9 depicts an example of configuration of a set of RBs for flexible uplink transmission skipping, in accordance with aspects of the present disclosure.

FIG. 10 depicts an example set of RB groups for flexible uplink transmission skipping, in accordance with aspects of the present disclosure.

FIG. 11 depicts an example configuration of a set of RBs for flexible uplink transmission skipping based on a reference RB, in accordance with aspects of the present disclosure

FIG. 12 depicts a method for wireless communications.

FIG. 13 depicts a method for wireless communications.

FIG. 14 depicts aspects of an example communications device.

FIG. 15 depicts aspects of an example communications device.

### DETAILED DESCRIPTION

Aspects of the present disclosure provide apparatuses, methods, processing systems, and computer-readable mediums for flexible uplink transmission skipping.

There are various signaling and scheduling mechanisms on which uplink (UL) transmission from a user equipment (UE) may be based. For example, an uplink transmission may be based on a scheduling request (SR) and buffer status report (BSR). In this case, the UE first transmits SR requesting radio resources in the UL when it has pending data in its buffer. Along with periodic BSR reporting, the network entity (e.g., gNB) knows the available buffer at UE (and when it needs to transmit data to avoid overflowing the buffer). The network allocates resources for the UE to transmit over. While this mechanism efficiently matches UL resource allocation to the amount of data (information bits) at the UE, it might result in increased latency as the UE transmits an SR and waits for an uplink grant.

Another mechanism is SR/BSR based with pre-scheduling. In this case, the UE does not need to repeatedly send SRs, as the network continues to schedule the UE until a configurable timer expires, after the UE has reported zero BSR (indicating the UE's buffers are empty). Resources may be allocated for this timer period, even when the UE has no more data to transmit. Another mechanism is periodic scheduling, where the network schedules uplink resources at a fixed periodicity, irrespective of UE buffer status. Still another mechanism is based on what is referred to as an uplink configured grant (UL-CG). When configured with an UL-CG, the UE has periodic UL resources available for transmission and is not required to receive an UL grant before transmission. The pre-scheduling periodic scheduling, and UL-CG based mechanisms generally result in lower latency. Unfortunately, over allocation of UL resources is also possible with these mechanisms.

Aspects of the present disclosure provide mechanisms for flexible uplink transmission skipping that allows a UE to transmit over a subset of RBs out of the total set of allocated RBs. The mechanisms described herein may thus result in reduced latency while minimizing over allocation of UL resources.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

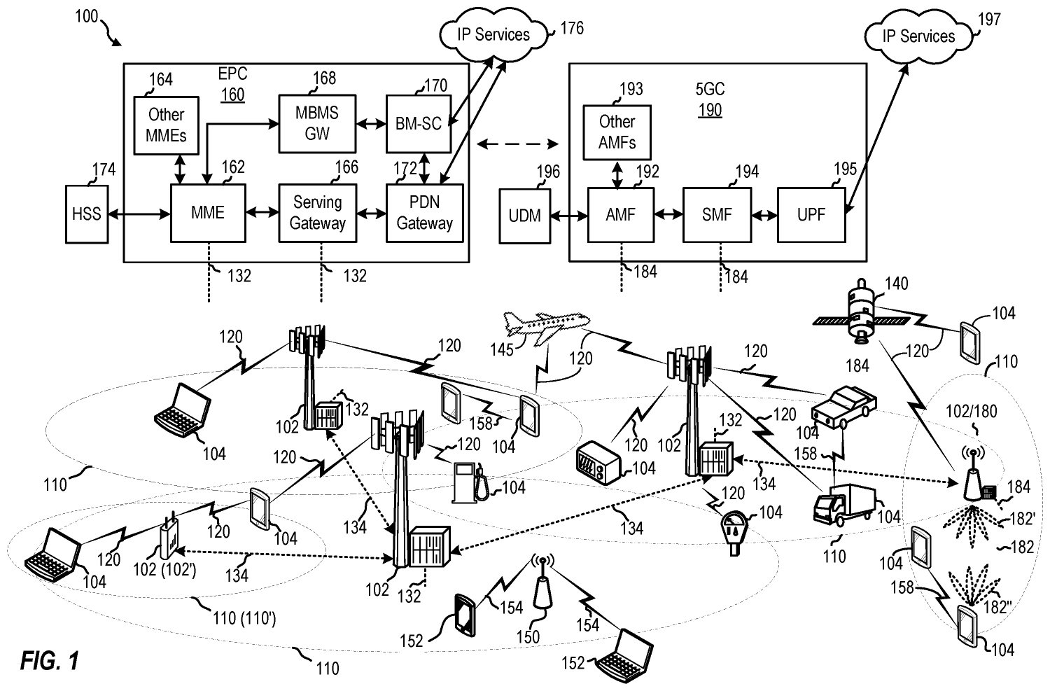

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

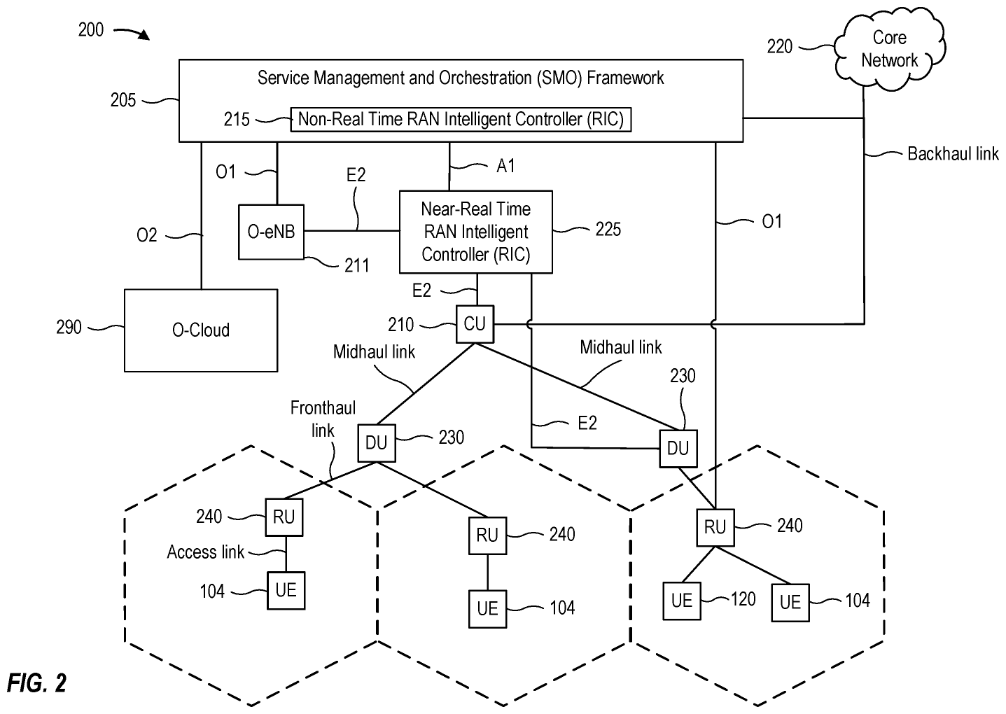

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMES 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (MC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT MC 225.

In some implementations, to generate AI/ML models to be deployed in the Near-RT MC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

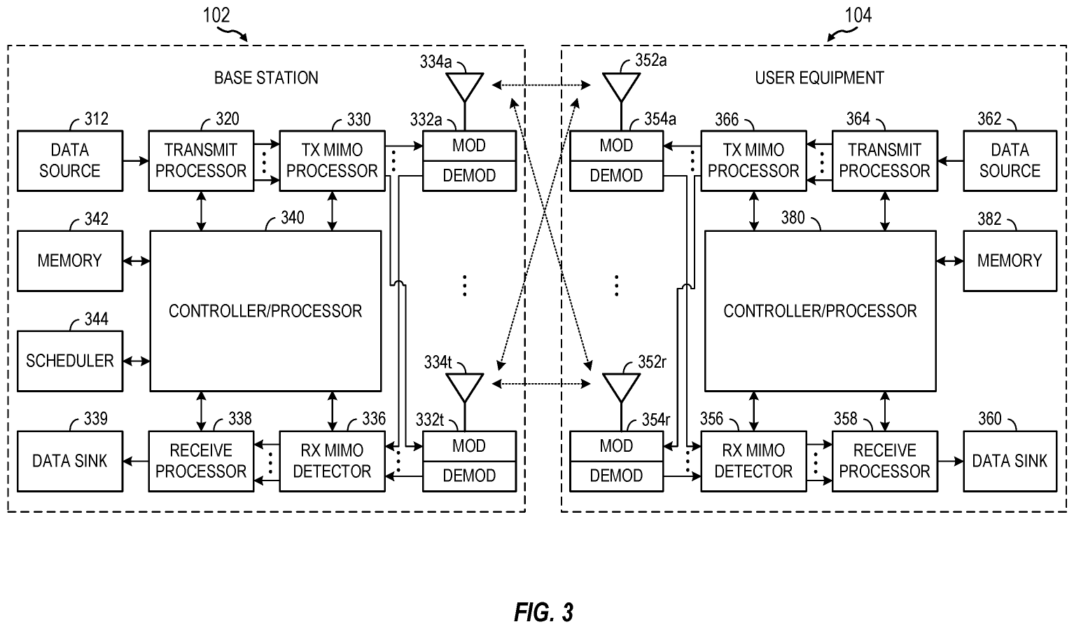

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

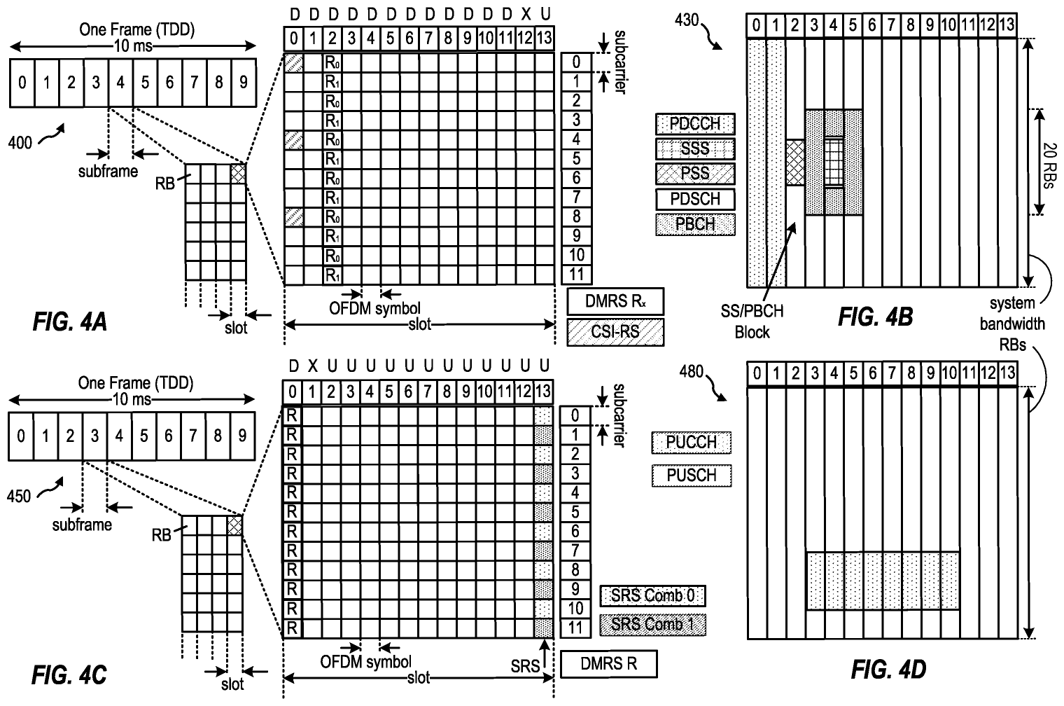

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Uplink Transmission Skipping

As noted above, conventional mechanisms on which UL transmissions from a UE are based are less than optimal. For example, SR and BSR based UL transmission scheduling may efficiently match UL resource allocation to the amount of data (information bits) at the UE, but can suffer from increased latency as the UE transmits an SR and waits for an uplink grant. UL transmission based on SR/BSR with pre-scheduling, periodic scheduling, or uplink configured grants (UL-CGs) may result in lower latency, but at the potential cost of over allocation of UL resources.

In some systems (e.g., NR Rel-15 and Rel-16) medium access control (MAC) based enhancements have been introduced that allow a UE to skip (e.g., ignore) configured (whether dynamically or semi-statically) resources.

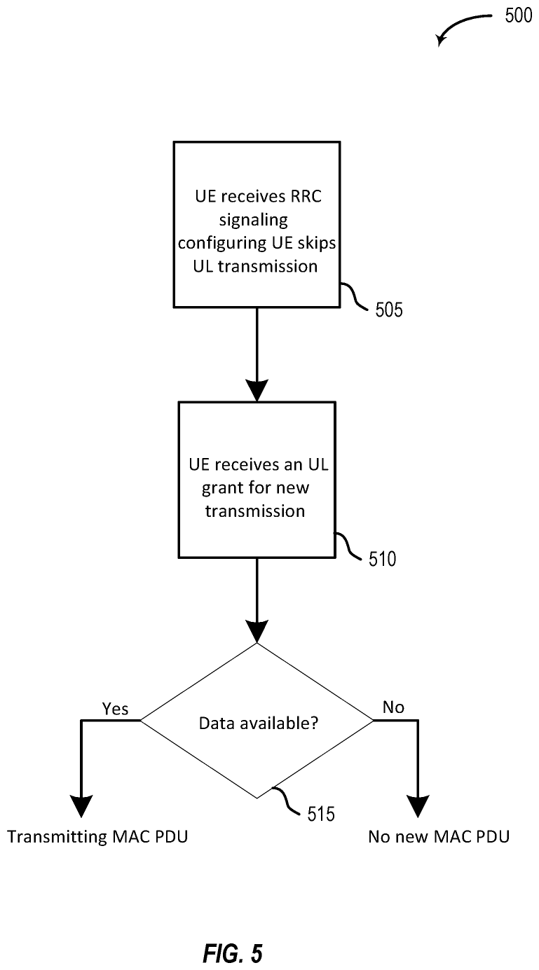

FIG. 5 depicts a flow diagram 500 for this type of skipping. As illustrated, at 505, the UE may receive radio resource control (RRC) signaling configuring the UE to skip uplink transmissions. At 510, the UE receives an uplink grant for a new transmission. If there is data available, as determined at 515, the UE may transmit the data in a MAC protocol data unit (PDU). If there is no data available, there may be no new MAC PDU and the UE may skip the transmit opportunity to transmit on the configured resources.

Even with this enhancement, when not skipping, a UE may exhibit conventional legacy behavior that results in resource wastage as the configured resources may be more than necessary for the amount of data the UE has to transmit. In such cases, the UE may exhibit conventional (legacy) behavior and transmit padded bits over the allocated resource blocks (RBs), even though the information bits may not require the over-allocated number of RBs for transmission.

With the enhancements discussed above, the potential benefits arise from the fact that, if a UE has no PDCP packets pending, then UL resources are not wasted. In this case, resource utilization is improved and power consumption decreases. However, if the UE has only a few information bits to transmit (requiring only a few RBs or subset of the RBs from the full set of allocated RBs), then the UE would not be able to transmit these few bits if the UE skipped the entire transmission opportunity. In one conventional case, the prescheduling of the UEs (e.g., grant free) with the possibility of over allocation may decrease the latency as the gNB would not have to wait for SR from UE to assign resources in the UL using UL grant. However, this would result in high resource utilization, an increase in interference in the uplink, and higher power consumption. The higher power consumption may increase the thermal state of the UE. This is in particular important issue for certain devices, such as extended reality (XR) or other augmented reality (AR) devices that have a small form factor.

These conventional approaches are not optimal for the event that the UE has fewer information bits which would require the use of a subset of the RBs or few RBs out of all the assigned RBs. As an example, a network entity (e.g., a gNB) may allocate, in 20 MHz system bandwidth, all 50 available RBs in the UL for a UE assuming a 30 kHz subcarrier spacing (SCS). If the UL Transport Block Size (TBS) for a physical uplink shared channel (PUSCH) transmission requires only 10 RBs, it would be ideal if the UE were to only 10 RBs. However, with the conventional uplink transmission skipping feature described above, such ideal utilization is not possible.

Aspects of the present disclosure provide mechanisms for flexible uplink transmission skipping that allows a UE to transmit over a subset of RBs out of the total set of allocated RBs. The mechanisms described herein may thus result in reduced latency while minimizing over allocation of UL resources.

According to the flexible uplink transmission skipping proposed herein, the number of RBs that a UE uses may be subset of the total assigned UL resources in the UL grant. As used herein, the term flexible uplink transmission skipping generally refers to the capability of a UE to not just skip all resources allocated for an entire uplink transmissions, but to use a reduced set of the allocated resources for an uplink transmission (e.g., and skip a remaining portion of the resources). The reduced set of resource may help reduce the potential waste described above due to over-allocation of UL resources. As will be described in greater detail below, the reduced set could be a reduced set of frequency resources (e.g., a reduced set of RBs) or a reduced set of symbols (e.g., a reduced set of symbols).

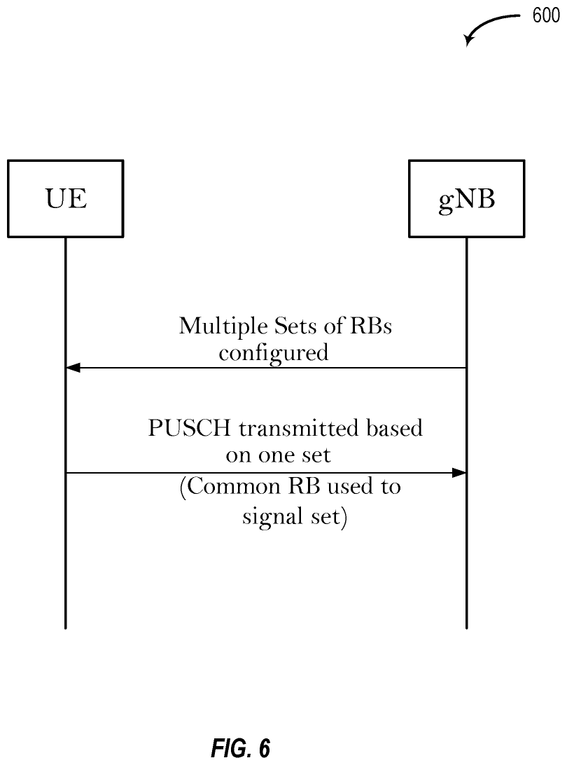

Flexible uplink transmission skipping proposed herein may be understood with reference to the call flow diagram 600 of FIG. 6. As illustrated, a UE may be configured with multiple sets of RBs. When transmitting a PUSCH, however, the UE may only transmit on one of the configured sets of RBs.

For use cases, such as XR, that tend to have larger packet size variation, flexibility in scheduling UL resources is desirable. The flexible uplink transmission skipping proposed herein may be applied in a variety of deployment scenarios, such as Rel-16 NR unlicensed (NR-U), where a UE may receive a wideband UL allocation (more than 20 MHz) since the channel access is per 20 MHz, per unlicensed band. In such cases, the UE may gain access (pass a look before talk-LBT procedure) only over some part of the channel/allocation. In some cases, the techniques presented herein may help a UE comply with maximum permissible exposure (MPE) regulatory constraints (e.g., in mmWave) where the energy available in the UL may be limited and wasting power to transmit padding bits should be avoided.

As used herein, skipping generally refers to refraining from transmitting on some portion of resource allocated to a UE for uplink transmission. Aspects of the present disclosure provide various solutions for flexible uplink transmission skipping.

According to a first option, rather than signal a precise set of RBs, a network entity (e.g., a gNB) signals multiple sets of RBs that a UE may transmit on. The UE may pick one set to transmit on, while the gNB may perform a search over each of the configured sets to identify the set of RBs the UE transmitted on. The processing overhead associated with this searching may be acceptable, as the number of sets of RBs configured for any particular UE may be limited.

According to a second option, the gNB (or other network entity) may signal a range of RBs over which the UE can transmit. According to this option, the UE may select the particular number and set of RBs according to its own logic. For example, the particular number or set of RBs that the UE selects may be based on channel estimation or the number of information bits available.

According to this approach, there may be no explicit indication of a set of RBs. In some cases, the UE may select a set of RBs that optimize UL throughput. This may assume that the UE has estimated the downlink channel and that the uplink channel is reciprocal (e.g., in a time division duplexed TDD system). Other optimization metrics may be involved in selecting the RBs. According to certain aspects, the UE may choose to transmit over RBs that have favorable channel gain conditions.

For such cases of RB selection, various types of signaling may be utilized for configuring the set of RBs from which the UE may select. For example, the signaling may include RRC configuration of a set of RBs, RRC configuration a larger set of RBs or multiple RB sets coupled with down selection (e.g., MAC-CE based down selection) of a subset of the larger set of RBs, or RRC configuration coupled with DCI based down selection. In some cases, the signaling may include MAC-CE based configuration or MAC-CE based configuration coupled with DCI based down selection.

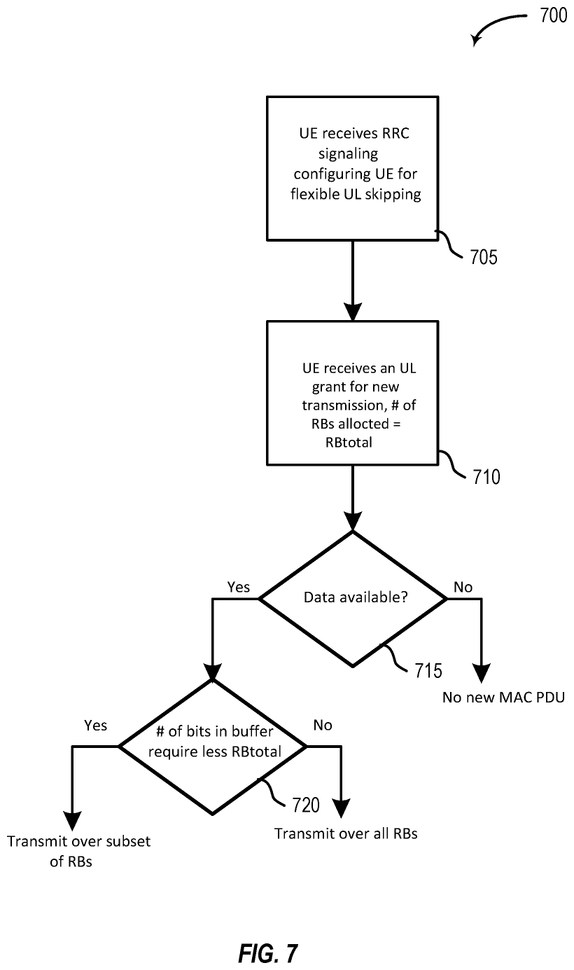

FIG. 7 depicts a flow diagram 700 for flexible uplink transmission skipping. As illustrated, at 705, the UE receives RRC signaling configuring the UE for flexible uplink transmission skipping. At 710, the UE receives an uplink grant for a new transmission. If there is no data available, as determined at 715, there may be no new MAC PDU and the UE may skip the transmit opportunity to transmit on the configured resources.

If there is data available, as determined at 715, rather than simply transmit the data in a MAC PDU, the UE may first determine, at 720, if the number of bits buffered at the UE requires less than a total number of RBs (RBₜₒₜₐₗ) allocated to the UE. If so, the UE may transmit over just a subset of (the total number of) RBs.

In some cases, before the network configures flexible uplink transmission skipping, it may confirm the UE supports such skipping. For example, a UE capability may be defined that indicates support of flexible UL skipping configuration. The UE capability may be exchanged after the UE has established a RRC connected mode.

In some cases, the capability may be separate for flexible skipping of UL resources associated with dynamic grants and configured grants. The signaling for dynamic grants versus configured grants may be different. In such cases, if a UE indicates it is capable of flexible skipping, further RRC configuration may be provided. According to the first option described above, a gNB may configure one or multiple sets of precise RBs. According to the second option, the gNB may configure only a range of RBs over which UE transmits on. In this case, a main set of RBs may be indicated (e.g., as in conventional/legacy RB signaling).

In some cases, an indication via RRC may be provided, such that capable UEs are informed they are allowed to transmit on reduced set of RBs. In one embodiment, the multiple configurations may include one common RB at least. In such cases, the UE may use some resource elements (REs) to signal the configuration that the UE has selected. This signaling may reduce searching overhead at the gNB.

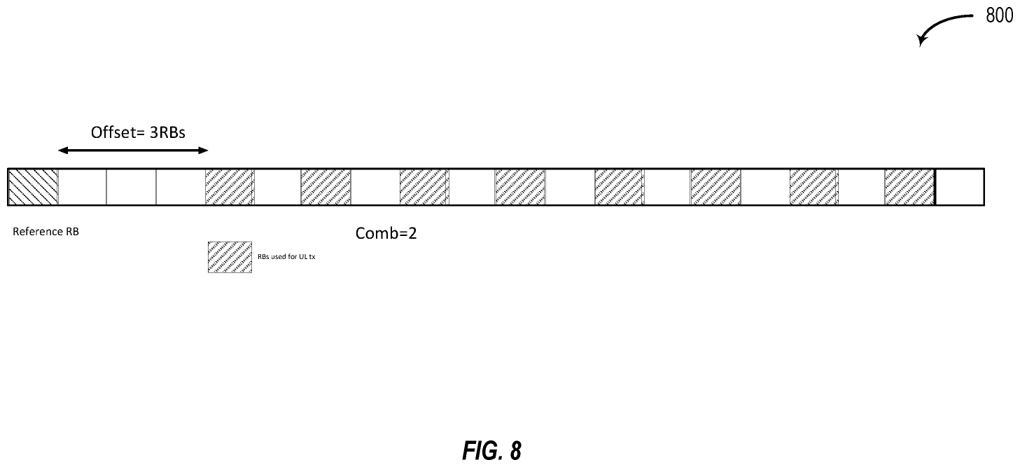

RRC signaling configuration may indicate to the UE for one or more sets of RB allocation. For example, as illustrated in the example RB grid 800 of FIG. 8, a reference RB may be defined. The RBs used for UL transmission may be defined relative to this reference RB.

In some cases, the reference RB may be defined over the system bandwidth. In such cases, the configuration may then be defined with respect to the reference RB. As an alternative, a reference RB may be defined over a bandwidth part (BWP). An offset from the reference RB may be signaled to indicate the first RB that the UE is allowed to use for transmission. As an example, if this offset value is 0, then the reference RB would be the first RB used for transmission. In some cases, an RB allocation may include a comb pattern (e.g., with the comb pattern formed of evenly spaced RBs).

In the example illustrated in FIG. 8, all RBs of grid 800 may be initially assigned to the UE through an UL grant or Configured Grant. The UE may not require all RBs for transmission of a smaller PDU. Therefore, flexible UL skipping may be used to allow the UE to transmit over only a subset of RBs. The reference RB may be used along with the offset to allow the UE to locate its first RB for transmission. In the illustrated example, Comb=2, Offset=3.

In the event that a UE wants to transmit over fewer RBs than the full set of RBs configured by the gNB, the UE may start by selecting RBs closer to a reference RB and skip the rest of the RBs. Because the gNB would know the UE applies such prioritization, the gNB would know which of the “selected RBs” have been further down-selected by the UE.

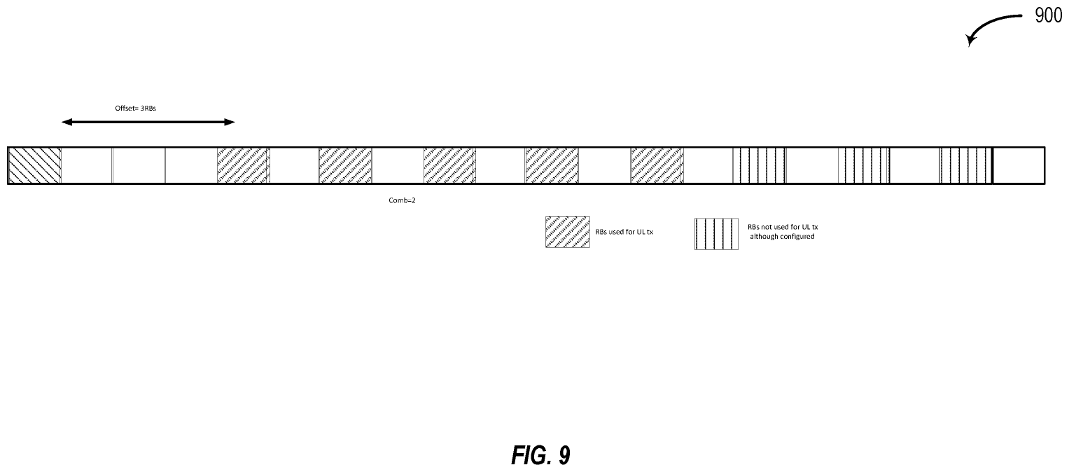

FIG. 9 illustrates one example 900 of such down selection by a UE. The illustrated example assumes a gNB configured the first 8 RBs offset from a given Reference RB as part of the flexible UL transmission. In the illustrated example, the UE has found that only 5 RBs are needed for its uplink transmission. As illustrated, the priority may be given to the RBs closest to the Reference RB (e.g., the first 5 RBs from reference RB0 in the illustrated example).

In some cases, with a fixed configuration assigned by the gNB (as opposed to allowing the UE to choose its own subset of RBs), a UE may be configured to follow the configured indication and may only transmit accordingly. After demodulation, the gNB would know the RBs used by the UE

According to certain aspects, multiple configurations may be RRC configured, and a MAC CE may activate any of the configurations. In some cases, a DCI indication may also indicate dynamically which of the configurations the UE has to follow for selection of RBs for UL transmission. For example, for 8 configurations, 3 bits in the DCI may indicate the selection. The dynamic indication may be ideal for the case where the gNB has multiple users in the UL and when the gNB may want to optimize the resources over the users.

A single activation/deactivation command can activate/deactivate a subset of RBs in the event the UE may transmit over subset of RBs. Since the total number of RBs may be large (e.g., 273 RBs for 100 MHz), a bitmap per RB may not be ideal. In one embodiment, the bitmap may refer to grouping of contiguous RBs.

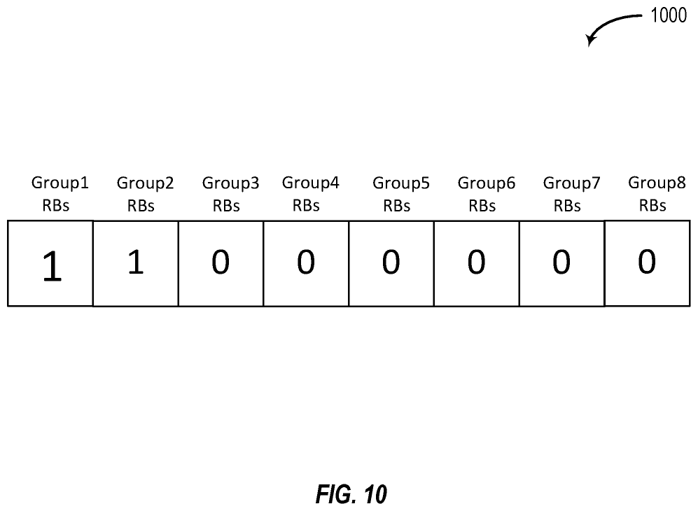

For example, FIG. 10 illustrates example RB groups that may be activated via a MAC CE. In the illustrated example, the UE may transmit over Group 1 and Group 2 (as indicated by the ‘1’).

In some cases, with a system bandwidth of 20 MHz and with a 30 kHz SCS, the total number of RBs may be 50. In such cases, the number of RBs in Group 1, 2, 3, 4, 5, 6, 7=7 RBs. The last group may contain 1 RB. In this configuration, the first two groups may be activated for UE to transmit over. In some cases, the UE may decide to further down-select to Group1, for example, in the case that fewer RBs are needed by the UE than those “selected RBs” of the gNB. In some cases, a DCI indication may be used to downselect from multiple MAC CE configurations.

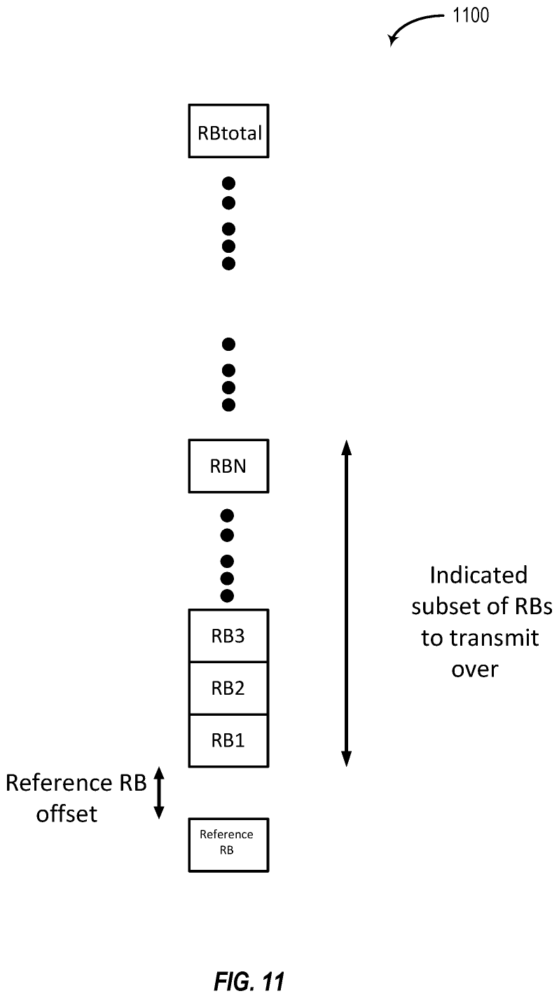

According to certain aspects, a table may be defined (e.g., in a standard specification) that includes the TBS and the RBs allocation used. The diagram 1100 of FIG. 11 illustrates how a subset of N RBs may be allocated.

In some cases, a table entry may indicate that, if a TBS is within a certain range (e.g., A<TBS<=B) the 10 RBs (e.g., RB1-10) out of total assigned RBs may be used. On the other hand, if the TBS is in a different range (e.g., B<TBS<=C) then RB1-20 out of the total assigned RBs may be used. In some cases, a reference RB may be provided in BWP or system bandwidth. The reference may be used with a table to figure out the RBs.

### Example Operations of a User Equipment

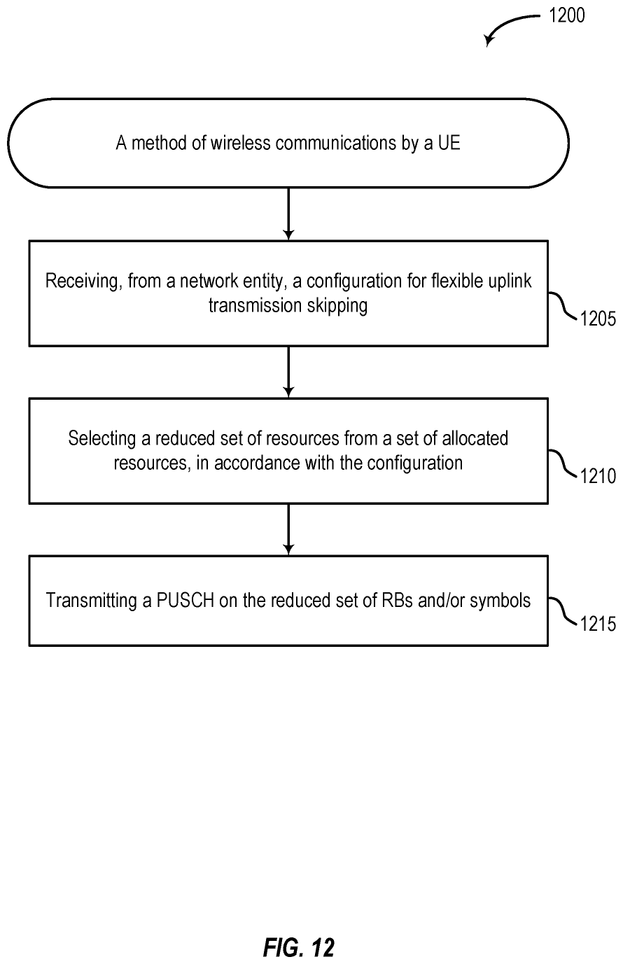

FIG. 12 shows a method 1200 for wireless communications by a UE, such as UE 104 of FIGS. 1 and 3.

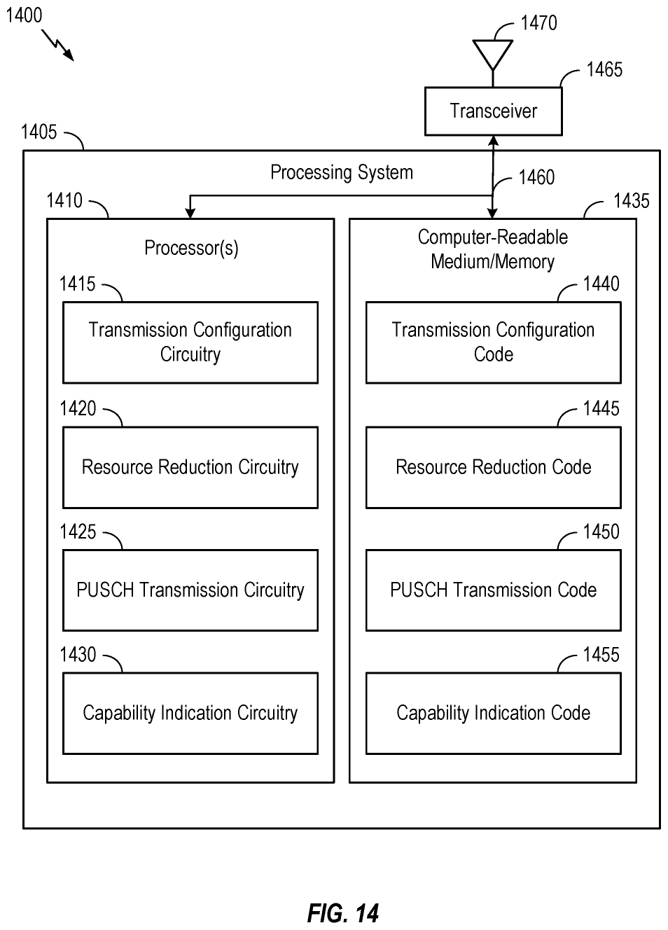

Method 1200 begins at 1205 with receiving, from a network entity, a configuration for flexible uplink transmission skipping. In some cases, the operations of this step refer to, or may be performed by, transmission configuration circuitry as described with reference to FIG. 14.

Method 1200 then proceeds to step 1210 with selecting a reduced set of resources from a set of allocated resources, in accordance with the configuration. In some cases, the operations of this step refer to, or may be performed by, resource reduction circuitry as described with reference to FIG. 14.

Method 1200 then proceeds to step 1215 with transmitting a PUSCH on the reduced set of resources. In some cases, the operations of this step refer to, or may be performed by, PUSCH transmission circuitry as described with reference to FIG. 14.

In some aspects, the reduced set of resources comprises at least one of: a reduced set of RBs or a reduced set of symbols. In some aspects, the set of allocated resources are dynamically allocated via an uplink grant or semi-statically allocated via a configured grant.

In some aspects, the method 1200 further includes transmitting, to the network entity, an indication of a capability of the UE to support flexible uplink transmission skipping. In some aspects, the method 1200 further includes receiving the configuration for flexible uplink transmission skipping after transmitting the indication.

In some aspects, the UE indicates: a first capability to support flexible uplink transmission skipping for uplink transmissions sent on resources allocated to the UE dynamically via an uplink grant; and a second capability to support flexible uplink transmission skipping for uplink transmissions sent on resources allocated to the UE semi-statically via a configured grant.

In some aspects, receiving the configuration comprises: receiving, via at least one of RRC or MAC CE signaling, an indication of a first set of resources. In some aspects, the method 1200 further includes receiving, via at least one of MAC CE or DCI signaling, an indication of a subset of the first set of resources available for flexible uplink transmission. In some aspects, the method 1200 further includes selecting the reduced set of RBs from the subset. In some aspects, the first set of resources comprises groups of resources; and the MAC CE or DCI indicating the subset comprises bits, each associated with one of the groups of resources.

In some aspects, the configuration for flexible uplink transmission skipping indicates multiple sets of resources; and selecting the reduced set of resources comprises selecting one of the multiple sets. In some aspects, the one of the multiple sets of resources is selected based on at least one of: channel estimation performed at the UE; or a number of information bits to transmit in the PUSCH.

In some aspects, the configuration indicates a range of resources available for flexible uplink transmission skipping; and selecting the reduced set of resources comprises selecting a subset of resources within the range. In some aspects, the subset of resources within the range is selected based on at least one of: channel estimation performed at the UE; a number of information bits to transmit in the PUSCH; or estimated uplink throughout using the selected subset of resources relative to other subsets of resources within the range.

In some aspects, the configuration indicates one or more sets of RBs via one or more offsets relative to a reference RB. In some aspects, the reference RB comprises an RB within operating system bandwidth or a BWP. In some aspects, the configuration also indicates a comb structure that defines at least one of the one or more sets of RBs. In some aspects, the configuration indicates the one or more sets of RBs relative to a reference RB. In some aspects, the reduced set of resources comprises a subset of one of the one or more sets of RBs. In some aspects, the reduced set of resources is selected, from a set of resources allocated to the UE, based on a TBS for a payload of the PUSCH.

In one aspect, method 1200, or any aspect related to it, may be performed by an apparatus, such as communications device 1400 of FIG. 14, which includes various components operable, configured, or adapted to perform the method 1200. Communications device 1400 is described below in further detail.

Note that FIG. 12 is just one example of a method, and other methods including fewer, additional, or alternative steps are possible consistent with this disclosure.

### Example Operations of a Network Entity

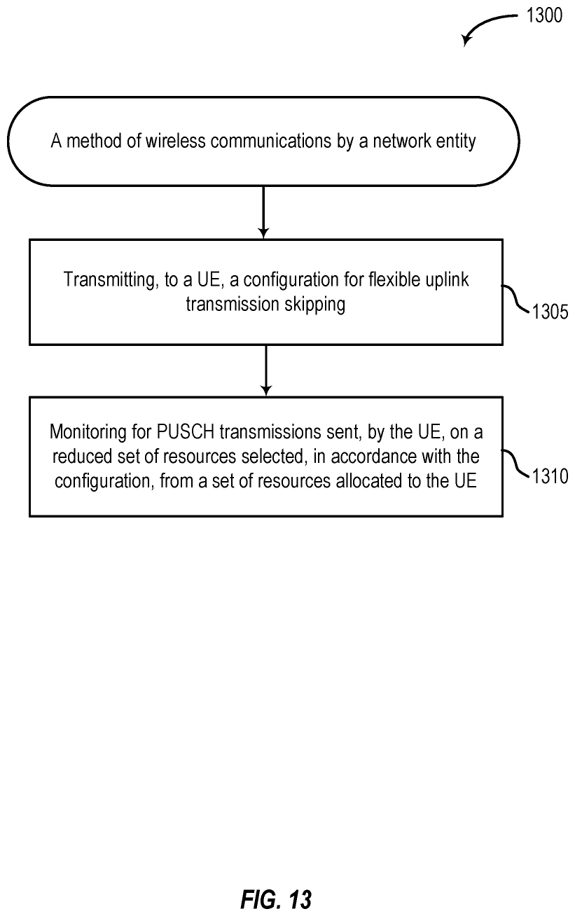

FIG. 13 shows a method 1300 for wireless communications by a network entity, such as BS 102 of FIGS. 1 and 3, or a disaggregated base station as discussed with respect to FIG. 2.

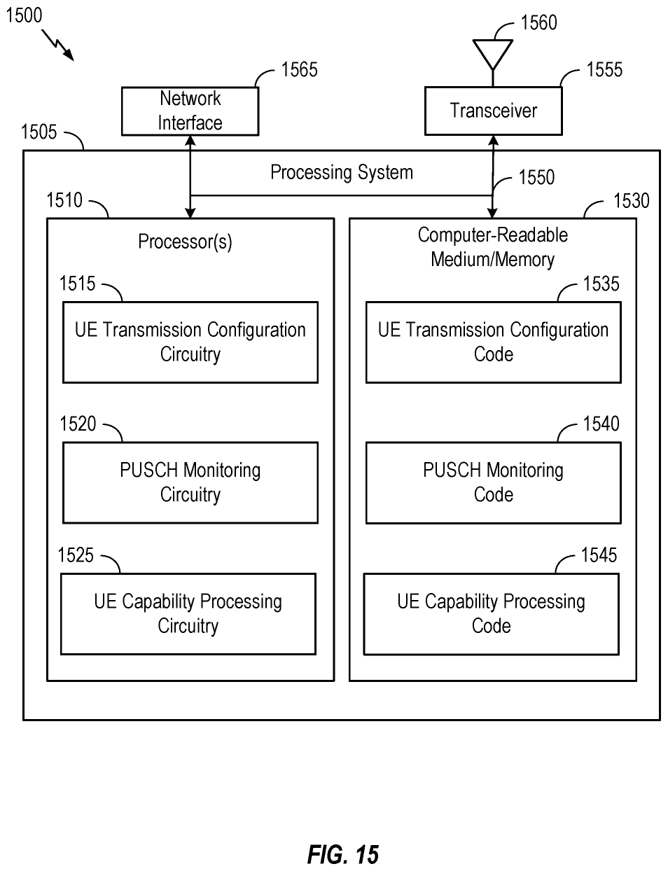

Method 1300 begins at 1305 with transmitting, to a UE, a configuration for flexible uplink transmission skipping. In some cases, the operations of this step refer to, or may be performed by, UE transmission configuration circuitry as described with reference to FIG. 15.

Method 1300 then proceeds to step 1310 with monitoring for PUSCH transmissions sent, by the UE, on a reduced set of resources selected, in accordance with the configuration, from a set of resources allocated to the UE. In some cases, the operations of this step refer to, or may be performed by, PUSCH monitoring circuitry as described with reference to FIG. 15.

In some aspects, the reduced set of resources comprises at least one of: a reduced set of RBs or a reduced set of symbols. In some aspects, monitoring for PUSCH transmissions comprises performing blind decoding on the reduced set of resources. In some aspects, the set of resources allocated to the UE are dynamically allocated via an uplink grant or semi-statically allocated via a configured grant.

In some aspects, the method 1300 further includes obtaining an indication of a capability of the UE to support flexible uplink transmission. In some aspects, the method 1300 further includes transmitting the configuration for flexible uplink transmission after obtaining the indication.

In some aspects, the network entity transmits: a first configuration for flexible uplink transmission for uplink transmissions sent on resources allocated to the UE dynamically via an uplink grant; and a first configuration for flexible uplink transmission for uplink transmissions sent on resources allocated to the UE semi-statically via a configured grant.

In some aspects, transmitting the configuration comprises: transmitting, via at least one of RRC or MAC CE signaling, an indication of a first set of resources. In some aspects, the method 1300 further includes transmitting, via at least one of MAC CE or DCI signaling, an indication of a subset of the first set of RBs available for flexible uplink transmission. In some aspects, the method 1300 further includes monitoring for PUSCH transmissions on the reduced set of resources from the subset.

In some aspects, the first set of resources comprises groups of resources; and the MAC CE or DCI indicating the subset comprises bits, each associated with one of the groups of resources.

In some aspects, the configuration indicates multiple sets of resources available for flexible uplink transmission; and selecting the reduced set of resources comprises selecting one of the multiple sets of resources. In some aspects, the configuration indicates a range of resources available for flexible uplink transmission; and selecting the reduced set of resources comprises selecting a subset of resources within the range.

In some aspects, the configuration for flexible uplink transmission indicates one or more sets of RBs via one or more offsets relative to a reference RB. In some aspects, the reference RB comprises a reference RB within operating system bandwidth or a BWP. In some aspects, the configuration also indicates a comb structure that defines at least one of the one or more sets of RBs. In some aspects, the configuration for flexible uplink transmission indicates the one or more sets of RBs relative to a reference RB.

In some aspects, the reduced set of RBs comprises a subset of one of the one or more sets of RBs. In some aspects, the network entity monitors for PUSCH transmissions on reduced sets of resources selected, from a set of resources allocated to the UE, based on different TBSs for payloads of the PUSCHs.

In one aspect, method 1300, or any aspect related to it, may be performed by an apparatus, such as communications device 1500 of FIG. 15, which includes various components operable, configured, or adapted to perform the method 1300. Communications device 1500 is described below in further detail.

Note that FIG. 13 is just one example of a method, and other methods including fewer, additional, or alternative steps are possible consistent with this disclosure.

### Example Communications Devices

FIG. 14 depicts aspects of an example communications device 1400. In some aspects, communications device 1400 is a user equipment, such as UE 104 described above with respect to FIGS. 1 and 3.

The communications device 1400 includes a processing system 1405 coupled to the transceiver 1465 (e.g., a transmitter and/or a receiver). The transceiver 1465 is configured to transmit and receive signals for the communications device 1400 via the antenna 1470, such as the various signals as described herein. The processing system 1405 may be configured to perform processing functions for the communications device 1400, including processing signals received and/or to be transmitted by the communications device 1400.

The processing system 1405 includes one or more processors 1410. In various aspects, the one or more processors 1410 may be representative of one or more of receive processor 358, transmit processor 364, TX MIMO processor 366, and/or controller/processor 380, as described with respect to FIG. 3. The one or more processors 1410 are coupled to a computer-readable medium/memory 1435 via a bus 1460. In certain aspects, the computer-readable medium/memory 1435 is configured to store instructions (e.g., computer-executable code) that when executed by the one or more processors 1410, cause the one or more processors 1410 to perform the method 1200 described with respect to FIG. 12, or any aspect related to it. Note that reference to a processor performing a function of communications device 1400 may include one or more processors 1410 performing that function of communications device 1400.

In the depicted example, computer-readable medium/memory 1435 stores code (e.g., executable instructions), such as transmission configuration code 1440, resource reduction code 1445, PUSCH transmission code 1450, and capability indication code 1455. Processing of the transmission configuration code 1440, resource reduction code 1445, PUSCH transmission code 1450, and capability indication code 1455 may cause the communications device 1400 to perform the method 1200 described with respect to FIG. 12, or any aspect related to it.

The one or more processors 1410 include circuitry configured to implement (e.g., execute) the code stored in the computer-readable medium/memory 1435, including circuitry such as transmission configuration circuitry 1415, resource reduction circuitry 1420, PUSCH transmission circuitry 1425, and capability indication circuitry 1430. Processing with transmission configuration circuitry 1415, resource reduction circuitry 1420, PUSCH transmission circuitry 1425, and capability indication circuitry 1430 may cause the communications device 1400 to perform the method 1200 described with respect to FIG. 12, or any aspect related to it.

Various components of the communications device 1400 may provide means for performing the method 1200 described with respect to FIG. 12, or any aspect related to it. For example, means for transmitting, sending or outputting for transmission may include transceivers 354 and/or antenna(s) 352 of the UE 104 illustrated in FIG. 3 and/or the transceiver 1465 and the antenna 1470 of the communications device 1400 in FIG. 14. Means for receiving or obtaining may include transceivers 354 and/or antenna(s) 352 of the UE 104 illustrated in FIG. 3 and/or the transceiver 1465 and the antenna 1470 of the communications device 1400 in FIG. 14.

According to some aspects, transmission configuration circuitry 1415 receives, from a network entity, a configuration for flexible uplink transmission skipping. According to some aspects, resource reduction circuitry 1420 selects a reduced set of resources from a set of allocated resources, in accordance with the configuration. According to some aspects, PUSCH transmission circuitry 1425 transmits a PUSCH on the reduced set of resources.

In some aspects, the reduced set of resources comprises at least one of: a reduced set of RBs or a reduced set of symbols. In some aspects, the set of allocated resources are dynamically allocated via an uplink grant or semi-statically allocated via a configured grant.

According to some aspects, capability indication circuitry 1430 transmits, to the network entity, an indication of a capability of the UE to support flexible uplink transmission skipping. In some examples, transmission configuration circuitry 1415 receives the configuration for flexible uplink transmission skipping after transmitting the indication. In some aspects, the UE indicates: a first capability to support flexible uplink transmission skipping for uplink transmissions sent on resources allocated to the UE dynamically via an uplink grant; and a second capability to support flexible uplink transmission skipping for uplink transmissions sent on resources allocated to the UE semi-statically via a configured grant. In some aspects, receiving the configuration comprises: receiving, via at least one of RRC or MAC CE signaling, an indication of a first set of resources.

In some examples, transmission configuration circuitry 1415 receives, via at least one of MAC CE or DCI signaling, an indication of a subset of the first set of resources available for flexible uplink transmission. In some examples, resource reduction circuitry 1420 selects the reduced set of RBs from the subset. In some aspects, the first set of resources comprises groups of resources; and the MAC CE or DCI indicating the subset comprises bits, each associated with one of the groups of resources. In some aspects, the configuration for flexible uplink transmission skipping indicates multiple sets of resources; and selecting the reduced set of resources comprises selecting one of the multiple sets. In some aspects, the one of the multiple sets of resources is selected based on at least one of: channel estimation performed at the UE; or a number of information bits to transmit in the PUSCH. In some aspects, the configuration indicates a range of resources available for flexible uplink transmission skipping; and selecting the reduced set of resources comprises selecting a subset of resources within the range. In some aspects, the subset of resources within the range is selected based on at least one of: channel estimation performed at the UE; a number of information bits to transmit in the PUSCH; or estimated uplink throughout using the selected subset of resources relative to other subsets of resources within the range.

In some aspects, the configuration indicates one or more sets of RBs via one or more offsets relative to a reference RB. In some aspects, the reference RB comprises an RB within operating system bandwidth or a BWP. In some aspects, the configuration also indicates a comb structure that defines at least one of the one or more sets of RBs. In some aspects, the configuration indicates the one or more sets of RBs relative to a reference RB. In some aspects, the reduced set of resources comprises a subset of one of the one or more sets of RBs. In some aspects, the reduced set of resources is selected, from a set of resources allocated to the UE, based on a TBS for a payload of the PUSCH.

FIG. 15 depicts aspects of an example communications device 1500. In some aspects, communications device 1500 is a network entity, such as BS 102 of FIGS. 1 and 3, or a disaggregated base station as discussed with respect to FIG. 2.

The communications device 1500 includes a processing system 1505 coupled to the transceiver 1555 (e.g., a transmitter and/or a receiver) and/or a network interface 1565. The transceiver 1555 is configured to transmit and receive signals for the communications device 1500 via the antenna 1560, such as the various signals as described herein. The network interface 1565 is configured to obtain and send signals for the communications device 1500 via communication link(s), such as a backhaul link, midhaul link, and/or fronthaul link as described herein, such as with respect to FIG. 2. The processing system 1505 may be configured to perform processing functions for the communications device 1500, including processing signals received and/or to be transmitted by the communications device 1500.

The processing system 1505 includes one or more processors 1510. In various aspects, one or more processors 1510 may be representative of one or more of receive processor 338, transmit processor 320, TX MIMO processor 330, and/or controller/processor 340, as described with respect to FIG. 3. The one or more processors 1510 are coupled to a computer-readable medium/memory 1530 via a bus 1550. In certain aspects, the computer-readable medium/memory 1530 is configured to store instructions (e.g., computer-executable code) that when executed by the one or more processors 1510, cause the one or more processors 1510 to perform the method 1300 described with respect to FIG. 13, or any aspect related to it. Note that reference to a processor of communications device 1500 performing a function may include one or more processors 1510 of communications device 1500 performing that function.

In the depicted example, the computer-readable medium/memory 1530 stores code (e.g., executable instructions), such as UE transmission configuration code 1535, PUSCH monitoring code 1540, and UE capability processing code 1545. Processing of the UE transmission configuration code 1535, PUSCH monitoring code 1540, and UE capability processing code 1545 may cause the communications device 1500 to perform the method 1300 described with respect to FIG. 13, or any aspect related to it.

The one or more processors 1510 include circuitry configured to implement (e.g., execute) the code stored in the computer-readable medium/memory 1530, including circuitry such as UE transmission configuration circuitry 1515, PUSCH monitoring circuitry 1520, and UE capability processing circuitry 1525. Processing with UE transmission configuration circuitry 1515, PUSCH monitoring circuitry 1520, and UE capability processing circuitry 1525 may cause the communications device 1500 to perform the method 1300 as described with respect to FIG. 13, or any aspect related to it.

Various components of the communications device 1500 may provide means for performing the method 1300 as described with respect to FIG. 13, or any aspect related to it. Means for transmitting, sending or outputting for transmission may include transceivers 332 and/or antenna(s) 334 of the BS 102 illustrated in FIG. 3 and/or the transceiver 1555 and the antenna 1560 of the communications device 1500 in FIG. 15. Means for receiving or obtaining may include transceivers 332 and/or antenna(s) 334 of the BS 102 illustrated in FIG. 3 and/or the transceiver 1555 and the antenna 1560 of the communications device 1500 in FIG. 15.

According to some aspects, UE transmission configuration circuitry 1515 transmits, to a UE, a configuration for flexible uplink transmission skipping. According to some aspects, PUSCH monitoring circuitry 1520 monitors for PUSCH transmissions sent, by the UE, on a reduced set of resources selected, in accordance with the configuration, from a set of resources allocated to the UE.

In some aspects, the reduced set of resources comprises at least one of: a reduced set of RBs or a reduced set of symbols. In some aspects, monitoring for PUSCH transmissions comprises performing blind decoding on the reduced set of resources. In some aspects, the set of resources allocated to the UE are dynamically allocated via an uplink grant or semi-statically allocated via a configured grant.

According to some aspects, UE capability processing circuitry 1525 obtains an indication of a capability of the UE to support flexible uplink transmission. In some examples, UE transmission configuration circuitry 1515 transmits the configuration for flexible uplink transmission after obtaining the indication. In some aspects, the network entity transmits: a first configuration for flexible uplink transmission for uplink transmissions sent on resources allocated to the UE dynamically via an uplink grant; and a first configuration for flexible uplink transmission for uplink transmissions sent on resources allocated to the UE semi-statically via a configured grant. In some aspects, transmitting the configuration comprises: transmitting, via at least one of RRC or MAC CE signaling, an indication of a first set of resources.

In some examples, UE transmission configuration circuitry 1515 transmits, via at least one of MAC CE or DCI signaling, an indication of a subset of the first set of RBs available for flexible uplink transmission. In some examples, PUSCH monitoring circuitry 1520 monitors for PUSCH transmissions on the reduced set of resources from the subset. In some aspects, the first set of resources comprises groups of resources; and the MAC CE or DCI indicating the subset comprises bits, each associated with one of the groups of resources. In some examples, the configuration indicates multiple sets of resources available for flexible uplink transmission; and selecting the reduced set of resources comprises selecting one of the multiple sets of resources. In some aspects, the configuration indicates a range of resources available for flexible uplink transmission; and selecting the reduced set of resources comprises selecting a subset of resources within the range.

In some aspects, the configuration for flexible uplink transmission indicates one or more sets of RBs via one or more offsets relative to a reference RB. In some aspects, the reference RB comprises a reference RB within operating system bandwidth or a BWP. In some aspects, the configuration also indicates a comb structure that defines at least one of the one or more sets of RBs. In some aspects, the configuration for flexible uplink transmission indicates the one or more sets of RBs relative to a reference RB. In some aspects, the reduced set of RBs comprises a subset of one of the one or more sets of RBs. In some aspects, the network entity monitors for PUSCH transmissions on reduced sets of resources selected, from a set of resources allocated to the UE, based on different TBSs for payloads of the PUSCHs.

### Example Clauses

Implementation examples are described in the following numbered clauses:

Clause 1: A method of wireless communication by a UE, comprising: receiving, from a network entity, a configuration for flexible uplink transmission skipping; selecting a reduced set of resources from a set of allocated resources, in accordance with the configuration; and transmitting a PUSCH on the reduced set of resources.

Clause 2: The method of Clause 1, wherein the reduced set of resources comprises at least one of: a reduced set of RBs or a reduced set of symbols.

Clause 3: The method of any one of Clauses 1 and 2, wherein the set of allocated resources are dynamically allocated via an uplink grant or semi-statically allocated via a configured grant.

Clause 4: The method of any one of Clauses 1-3, further comprising: transmitting, to the network entity, an indication of a capability of the UE to support flexible uplink transmission skipping; and receiving the configuration for flexible uplink transmission skipping after transmitting the indication.

Clause 5: The method of Clause 4, wherein the UE indicates: a first capability to support flexible uplink transmission skipping for uplink transmissions sent on resources allocated to the UE dynamically via an uplink grant; and a second capability to support flexible uplink transmission skipping for uplink transmissions sent on resources allocated to the UE semi-statically via a configured grant.

Clause 6: The method of any one of Clauses 1-5, wherein receiving the configuration comprises: receiving, via at least one of RRC or MAC CE signaling, an indication of a first set of resources.

Clause 7: The method of Clause 6, further comprising: receiving, via at least one of MAC CE or DCI signaling, an indication of a subset of the first set of resources available for flexible uplink transmission; and selecting the reduced set of RBs from the sub set.

Clause 8: The method of Clause 7, wherein: the first set of resources comprises groups of resources; and the MAC CE or DCI indicating the subset comprises bits, each associated with one of the groups of resources.

Clause 9: The method of any one of Clauses 1-8, wherein: the configuration for flexible uplink transmission skipping indicates multiple sets of resources; and selecting the reduced set of resources comprises selecting one of the multiple sets.

Clause 10: The method of Clause 9, wherein the one of the multiple sets of resources is selected based on at least one of: channel estimation performed at the UE; or a number of information bits to transmit in the PUSCH.

Clause 11: The method of any one of Clauses 1-10, wherein: the configuration indicates a range of resources available for flexible uplink transmission skipping; and selecting the reduced set of resources comprises selecting a subset of resources within the range.

Clause 12: The method of Clause 11, wherein the subset of resources within the range is selected based on at least one of: channel estimation performed at the UE; a number of information bits to transmit in the PUSCH; or estimated uplink throughout using the selected subset of resources relative to other subsets of resources within the range.

Clause 13: The method of any one of Clauses 1-12, wherein the configuration indicates one or more sets of RBs via one or more offsets relative to a reference RB.

Clause 14: The method of Clause 13, wherein the reference RB comprises an RB within operating system bandwidth or a BWP.

Clause 15: The method of Clause 13, wherein the configuration also indicates a comb structure that defines at least one of the one or more sets of RBs.

Clause 16: The method of Clause 13, wherein the configuration indicates the one or more sets of RBs relative to a reference RB.

Clause 17: The method of Clause 13, wherein the reduced set of resources comprises a subset of one of the one or more sets of RBs.

Clause 18: The method of any one of Clauses 1-17, wherein the reduced set of resources is selected, from a set of resources allocated to the UE, based on a TBS for a payload of the PUSCH.

Clause 19: A method of wireless communication by a network entity, comprising: transmitting, to a UE, a configuration for flexible uplink transmission skipping; and monitoring for PUSCH transmissions sent, by the UE, on a reduced set of resources selected, in accordance with the configuration, from a set of resources allocated to the UE.

Clause 20: The method of Clause 19, wherein the reduced set of resources comprises at least one of: a reduced set of RBs or a reduced set of symbols.

Clause 21: The method of any one of Clauses 19 and 20, wherein monitoring for PUSCH transmissions comprises performing blind decoding on the reduced set of resources.

Clause 22: The method of any one of Clauses 19-21, wherein the set of resources allocated to the UE are dynamically allocated via an uplink grant or semi-statically allocated via a configured grant.

Clause 23: The method of any one of Clauses 19-22, further comprising: obtaining an indication of a capability of the UE to support flexible uplink transmission; and transmitting the configuration for flexible uplink transmission after obtaining the indication.

Clause 24: The method of Clause 23, wherein the network entity transmits: a first configuration for flexible uplink transmission for uplink transmissions sent on resources allocated to the UE dynamically via an uplink grant; and a first configuration for flexible uplink transmission for uplink transmissions sent on resources allocated to the UE semi-statically via a configured grant.

Clause 25: The method of any one of Clauses 19-24, wherein transmitting the configuration comprises: transmitting, via at least one of RRC or MAC CE signaling, an indication of a first set of resources.

Clause 26: The method of Clause 25, further comprising: transmitting, via at least one of MAC CE or DCI signaling, an indication of a subset of the first set of RBs available for flexible uplink transmission; and monitoring for PUSCH transmissions on the reduced set of resources from the subset.

Clause 27: The method of Clause 26, wherein: the first set of resources comprises groups of resources; and the MAC CE or DCI indicating the subset comprises bits, each associated with one of the groups of resources.

Clause 28: The method of any one of Clauses 19-27, wherein: the configuration indicates multiple sets of resources available for flexible uplink transmission; and selecting the reduced set of resources comprises selecting one of the multiple sets of resources.

Clause 29: The method of any one of Clauses 19-28, wherein: the configuration indicates a range of resources available for flexible uplink transmission; and selecting the reduced set of resources comprises selecting a subset of resources within the range.

Clause 30: The method of any one of Clauses 19-29, wherein the configuration for flexible uplink transmission indicates one or more sets of RBs via one or more offsets relative to a reference RB.

Clause 31: The method of Clause 30, wherein the reference RB comprises a reference RB within operating system bandwidth or a BWP.

Clause 32: The method of Clause 30, wherein the configuration also indicates a comb structure that defines at least one of the one or more sets of RBs.

Clause 33: The method of Clause 30, wherein the configuration for flexible uplink transmission indicates the one or more sets of RBs relative to a reference RB.

Clause 34: The method of Clause 30, wherein the reduced set of RBs comprises a subset of one of the one or more sets of RBs.

Clause 35: The method of any one of Clauses 19-34, wherein the network entity monitors for PUSCH transmissions on reduced sets of resources selected, from a set of resources allocated to the UE, based on different TBSs for payloads of the PUSCHs.

Clause 36: A processing system, comprising: a memory comprising computer-executable instructions; one or more processors configured to execute the computer-executable instructions and cause the processing system to perform a method in accordance with any one of Clauses 1-35.

Clause 37: A processing system, comprising means for performing a method in accordance with any one of Clauses 1-35.

Clause 38: A non-transitory computer-readable medium comprising computer-executable instructions that, when executed by one or more processors of a processing system, cause the processing system to perform a method in accordance with any one of Clauses 1-35.

Clause 39: A computer program product embodied on a computer-readable storage medium comprising code for performing a method in accordance with any one of Clauses 1-35.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communication at a user equipment (UE), comprising: a memory comprising computer-executable instructions; and one or more processors configured to execute the computer-executable instructions and cause the apparatus to:
receive, from a network entity, a configuration for flexible uplink transmission skipping;
select a reduced set of resources from a set of allocated resources, in accordance with the configuration; and
transmit a physical uplink shared channel (PUSCH) on the reduced set of resources.

2. The apparatus of claim 1, wherein the reduced set of resources comprises at least one of: a reduced set of resource blocks (RBs) or a reduced set of symbols.

3. The apparatus of claim 1, wherein the set of allocated resources are dynamically allocated via an uplink grant or semi-statically allocated via a configured grant.

4. The apparatus of claim 1, wherein the one or more processors are further configured to execute the computer-executable instructions and cause the apparatus to:
transmit, to the network entity, an indication of a capability of the UE to support flexible uplink transmission skipping; and
receive the configuration for flexible uplink transmission skipping after transmitting the indication.

5. The apparatus of claim 4, wherein the UE indicates:
a first capability to support flexible uplink transmission skipping for uplink transmissions sent on resources allocated to the UE dynamically via an uplink grant; and
a second capability to support flexible uplink transmission skipping for uplink transmissions sent on resources semi-statically allocated to the UE via a configured grant.

6. The apparatus of claim 1, wherein receiving the configuration comprises:
receiving, via at least one of radio resource control (RRC) or medium access control (MAC) control element (CE) signaling, an indication of a first set of resources.

7. The apparatus of claim 6, wherein the one or more processors are further configured to execute the computer-executable instructions and cause the apparatus to:
receive, via at least one of MAC CE or downlink control information (DCI) signaling, an indication of a subset of the first set of resources available for flexible uplink transmission; and
select the reduced set of resources from the subset.

8. The apparatus of claim 7, wherein:
the first set of resources comprises groups of resources; and
the MAC CE or DCI indicating the subset comprises bits, each associated with one of the groups of resources.

9. The apparatus of claim 1, wherein the:
the configuration for flexible uplink transmission skipping indicates multiple sets of resources; and
selecting the reduced set of resources comprises selecting one of the multiple sets of resources.

10. The apparatus of claim 9, wherein the one of the multiple sets of resources is selected based on at least one of:
channel estimation performed at the UE; or
a number of information bits to transmit in the PUSCH.

11. The apparatus of claim 1, wherein:
the configuration indicates a range of resources available for flexible uplink transmission skipping; and
selecting the reduced set of resources comprises selecting a subset of resources within the range.

12. The apparatus of claim 11, wherein the subset of resources within the range is selected based on at least one of:
channel estimation performed at the UE;
a number of information bits to transmit in the PUSCH; or
estimated uplink throughout using the selected subset of resources relative to other subsets of resources within the range.

13. The apparatus of claim 1, wherein the configuration indicates one or more sets of resource blocks (RBs) via one or more offsets relative to a reference RB.

14. The apparatus of claim 13, wherein the reference RB comprises an RB within operating system bandwidth or a bandwidth part (BWP).

15. The apparatus of claim 13, wherein the configuration also indicates a comb structure that defines at least one of the one or more sets of RBs.

16. The apparatus of claim 13, wherein the configuration indicates the one or more sets of RBs relative to a reference RB.

17. The apparatus of claim 13, wherein the reduced set of resources comprises a subset of one of the one or more sets of RBs.

18. The apparatus of claim 1, wherein:
The reduced set of resources is selected, from a set of resources allocated to the UE, based on a transport block size (TBS) for a payload of the PUSCH.

19. An apparatus for wireless communication at a network entity, comprising: a memory comprising computer-executable instructions; and one or more processors configured to execute the computer-executable instructions and cause the apparatus to:
transmit, to a user equipment (UE), a configuration for flexible uplink transmission skipping; and
monitor for physical uplink shared channel (PUSCH) transmissions sent, by the UE, on a reduced set of resources selected, in accordance with the configuration, from a set of resources allocated to the UE.

20. The apparatus of claim 19, wherein the reduced set of resources comprises at least one of: a reduced set of resource blocks (RBs) or a reduced set of symbols.

21. The apparatus of claim 19, wherein monitoring for PUSCH transmissions comprises performing blind decoding on the reduced set of resources.

22. The apparatus of claim 19, wherein the set of resources allocated to the UE are dynamically allocated via an uplink grant or semi-statically allocated via a configured grant.

23. The apparatus of claim 19, wherein the one or more processors are further configured to execute the computer-executable instructions and cause the apparatus to:
obtain an indication of a capability of the UE to support flexible uplink transmission; and
transmit the configuration for flexible uplink transmission after obtaining the indication.

24. The apparatus of claim 19, wherein transmitting the configuration comprises:
transmitting, via at least one of radio resource control (RRC) or medium access control (MAC) control element (CE) signaling, an indication of a first set of resources.

25. The apparatus of claim 19, wherein the:
the configuration indicates multiple sets of resources available for flexible uplink transmission; and
selecting the reduced set of resources comprises selecting one of the multiple sets of resources.

26. The apparatus of claim 19, wherein:
the configuration indicates a range of resources available for flexible uplink transmission; and
selecting the reduced set of resources comprises selecting a subset of resources within the range.

27. The apparatus of claim 19, wherein the configuration for flexible uplink transmission indicates one or more sets of resource blocks (RBs) via one or more offsets relative to a reference RB.

28. The apparatus of claim 19, wherein:
the network entity monitors for PUSCH transmissions on reduced sets of resources selected, from a set of resources allocated to the UE, based on different transport block sizes (TBSs) for payloads of the PUSCH transmissions.

29. A method of wireless communication by a user equipment (UE), comprising:
receiving, from a network entity, a configuration for flexible uplink transmission skipping;
selecting a reduced set of resources from a set of allocated resources, in accordance with the configuration; and
transmitting a physical uplink shared channel (PUSCH) on the reduced set of resources.

30. A method of wireless communication by a network entity, comprising:
transmitting, to a user equipment (UE), a configuration for flexible uplink transmission skipping; and
monitoring for physical uplink shared channel (PUSCH) transmissions sent, by the UE, on a reduced set of resources selected, in accordance with the configuration, from a set of resources allocated to the UE.
